(19) United States
(12) Patent Application Publication
(10) Pub. No.: US 2005/0104989 A1
(43) Pub. Date: May 19, 2005

(54) Dual-type solid state color image pickup apparatus and digital camera

(75) Inventor: Makoto Shizukuishi, Kurokawa-gun (JP)

Correspondence Address: BIRCH STEWART KOLASCH & BIRCH, PO BOX 747, FALLS CHURCH, VA, 22040-0747, US

(73) Assignee: Fuji Photo Film Co., Ltd.

(21) Appl. No.: 10/984,886

(22) Filed: Nov. 10, 2004

(30) Foreign Application Priority Data
Nov. 14, 2003 (JP) P. 2003-384643

(51) Int. Cl. H04N 9/07

(52) U.S. Cl. 348/337

(57) ABSTRACT

A dual-type solid state color image pickup apparatus has: a color separation prism which separates incident light from an object into first and second colors, and a third color of the three primary colors; a first solid state imaging device which receives incident light of the first and second colors separated by the color separation prism; and a second solid state imaging device which receives incident light of the third color separated by the color separation prism. Each of light receiving portions in the first solid state imaging device is configured by: a first-color detecting high-concentration impurity layer which detects an image signal corresponding to the amount of incident light of the first color; and a second-color detecting high-concentration impurity layer which is formed at a depth different from that of the impurity layer, and which detects an image signal corresponding to the amount of incident light of the second color.

### BACKGROUND OF THE INVENTION

1. Field of the Invention

The present invention relates to a dual-type solid state color image pickup apparatus and a digital camera on which the dual-type solid state color image pickup apparatus is mounted, and more particularly to a dual-type solid state color image pickup apparatus and a digital camera which have high sensitivity and excellent color reproducibility.

2. Description of the Related Art

In a solid state imaging device such as a CCD or a CMOS, miniaturization and increase of pixels are advancing. As a result, the resolution of an image picked up by a digital camera such as a digital video camera or a digital still camera on which such a solid state imaging device is mounted has reached to a level at which the resolution is comparable to that of an image obtained with using a silver halide film.

As a solid state color image pickup apparatus using a solid state imaging device(s), in the related art, known are apparatuses of the triple type, the dual type, and the single type.

As disclosed in, for example, JP-A-5-244613, a triple-type solid state color image pickup apparatus uses three solid state imaging devices in each of which a large number of photoelectrical converting elements are formed in an array pattern in the surface of a semiconductor substrate. Among optical images of an object, the optical image of red is received by the first solid state imaging device, that of green is received by the second solid state imaging device, and that of blue is received by the third solid state imaging device. Therefore, such an apparatus uses a color separation prism which separates incident light from an object into optical images of red (R), green (G), and blue (B). JP-A-48-37141 discloses a triple-type apparatus in which image pickup tubes are used in place of solid state imaging devices.

FIG. 23 is a diagram showing the configuration of an example of a color separation prism. The illustrated color separation prism 1 is configured by: a first prism member 1a; a second prism member 1b; a third prism member 1c; a blue-reflection dichroic film 2 which is disposed between the members 1a and 1b; and a red-reflection dichroic film 3 which is disposed between the members 1b and 1c.

Among R, G, and B optical images which are incident on the first prism member 1a, the optical image of blue (B) is reflected by the dichroic film 2 to be received by a third solid state imaging device 4. Among the optical images of red (R) and green (G) which are transmitted through the dichroic film 2, the optical image of red (R) is reflected by the dichroic film 3 to be received by a first solid state imaging device 5. The optical image of green (G) which is transmitted through the dichroic film 3 and then straight advances through the third prism member 1c is received by a second solid state imaging device 6.

The triple-type solid state color image pickup apparatus exerts high color separability so as not to wastefully use incident light, and hence has advantages that color reproducibility of a picked-up image is excellent, and that the sensitivity is high. In the apparatus, however, the complicated color separation prism 1 which has the three solid state imaging devices 4, 5, 6 is required, and the third prism member 1c cannot be omitted because the optical path lengths along which the color light beams of R, G, and B imaged by a condenser lens (not shown) that is placed in front of the prism 1 reach the solid state imaging devices 4, 5, 6, respectively must be equal to one another. Consequently, there arise problems in that the production cost is increased, and that the size of the apparatus is enlarged.

As disclosed in JP-A-5-244610 and JP-A-3-274523, for example, a dual-type solid state color image pickup apparatus is configured by using two solid state imaging devices, and a color separation prism having a structure which is simpler than that of the prism 1 shown in FIG. 23. FIG. 24 is a diagram showing the configuration of an example of a prism used in a dual-type solid state color image pickup apparatus. The color separation prism 7 is configured by a first prism member 7a, a second prism member 7b, and a green (G)-reflection dichroic film 8 which is disposed between the prism members. Among R, G, and B optical images which are incident on the first prism member 7a, the optical image of green (G) is reflected by the dichroic film 8 and then received by a first solid state imaging device 9, and the optical images of red (R) and blue (B) which are transmitted through the dichroic film 8 are received by a second solid state imaging device 10.

In order to enable the second solid state imaging device 10 to separately receive the optical images of red (R) and blue (B), a color filter 11 is disposed on the front face of the device 10. In the color filter 11, red (R) color filters and blue (B) color filters are alternately arranged in a striped pattern, so that photoelectrical converting elements placed on the back of the red filters detect the amount of red light, and those placed on the back of the blue filters detect the amount of blue light.

In the dual-type solid state color image pickup apparatus, the number of the solid state imaging devices is two, or smaller than that in the triple-type solid state color image pickup apparatus, and the prism 7 can be economically configured. Therefore, the production cost can be reduced. Since the color filter 11 is used, blue light incident on the red color filters, and red light incident on the blue color filters are not received by the photoelectrical converting elements to be wastefully used. Consequently, there arises a problem in that the sensitivity is lower than that of the triple-type apparatus. Moreover, the apparatus is configured so that incident light of red (R) and blue (B) straight advances to be received by the solid state imaging device 10. Therefore, the thickness of the second prism member 7b cannot be omitted, thereby causing another problem in that the thickness of the apparatus cannot be reduced.

In a single-type solid state color image pickup apparatus, R, G, and B optical images are received by a single solid state imaging device without using a color separation prism. Therefore, the apparatus is configured so that a color filter in which red (R) color filters, green (G) color filters, and blue (B) color filters are arranged in a mosaic pattern according to a predetermined rule is formed on the front face of the solid state imaging device, and each of many photoelectrical converting elements formed in the surface of a semiconductor substrate receives one of the R, G, and B optical images. FIG. 25 shows an example of such a color filter. The pattern of the color filter is called the Beyer pattern, and disclosed in U.S. Pat. No. 3,971,065.

In a single-type solid state color image pickup apparatus, only one solid state imaging device is necessary, and a color separation prism is not required. Therefore, the apparatus has advantages that the production cost is low, and that the apparatus can be reduced in size. However, light of green (G) and blue (B) incident on the red (R) color filters is not photoelectrically converted, and also light of red (R) and blue (B) incident on the green (G) color filters is not photoelectrically converted. Similarly, light of red (R) and green (G) incident on the blue (B) color filters is not photoelectrically converted. Therefore, only about one third of incident light is subjected to photoelectric conversion, thereby causing a problem in that the sensitivity is poor.

This problem can be avoided by employing a solid state color imaging device disclosed in U.S. Pat. No. 4,438,455, JP-A-1-134966 and U.S. Pat. No. 5,965,875. U.S. Pat. No. 4,438,455 discloses a solid state imaging device in which a color filter is not used, a multilayer structure of semiconductor photosensitive layers is stacked on a substrate, and red (R), green (G), and blue (B) of incident light are separately read by the respective photosensitive layers.

JP-A-1-134966 discloses a solid state imaging device in which a color filter is not mounted, three high-concentration impurity layers that are separated from one another in the depth direction are disposed in a semiconductor substrate, and red (R), green (G), and blue (B) of incident light are separately detected by the respective high-concentration impurity layers. This structure uses the optical property of a semiconductor disclosed in PAUL A. GARY, and JOHN G. LINVILL, “A Planar Silicon Photosensor with an Optimal Spectral Response for Detecting Printed Material,” IEEE TRANSACTIONS ON ELECTRON DEVICES, VOL. ED-15, NO. 1, JANUARY 1968, or that in which the photoelectrical conversion characteristics of a photoelectrical converting element depend on the wavelength of incident light and the position in the depth direction of a semiconductor substrate.

U.S. Pat. No. 5,965,875 disclose a CMOS image sensor in which a color filter is not mounted, and red (R), green (G), and blue (B) of incident light are separately detected with using the optical property of a semiconductor.

FIG. 26 is a section view of one pixel of the solid state color imaging device disclosed by JP-A-1-134966. In the solid state color imaging device, three high-concentration impurity layers 17, 18, 19 that are separated from one another in the depth direction are disposed in a P-well layer 16 formed in the surface of a semiconductor substrate. In light incident on the semiconductor substrate, light of blue (B) can penetrate only to a shallow position, light of red (R) can penetrate to a deep position, and light of green (G) can penetrate to an intermediate position. Therefore, photo-charges corresponding to the amount of incident light of blue (B) are accumulated in the shallowest high-concentration impurity layer 17, those corresponding to the amount of incident light of green (G) are accumulated in the intermediate high-concentration impurity layer 18, and those corresponding to the amount of incident light of red (R) are accumulated in the deepest high-concentration impurity layer 19.

FIG. 27 is a graph showing spectral characteristics of the colors of R, G, and B detected by the solid state imaging device shown in FIG. 26, and indicates that, even when a color filter is not used, the colors of red (R), green (G), and blue (B) can be separately detected. As seen from the graph, when the colors of R, G, and B are separated from one another with using the optical property of the semiconductor substrate, the separation of the colors of R, G, and B is not sufficiently conducted, and, for example, a photoelectrical converting element for detecting green (G) detects not only green but also red and blue, as green. When a picked-up image is reproduced on the basis of R, G, and B color signals detected by the solid state imaging device, consequently, there arises a problem in that high color reproducibility is hardly attained.

As described above, each of the triple-, dual-, and single-type solid state color image pickup apparatuses has both advantages and disadvantages. Therefore, the type of a solid state color image pickup apparatus which is to be mounted on a digital camera is determined in accordance with the production cost and the performance, and the size of the digital camera.

In a recent solid state imaging device in which miniaturization of pixels is advanced, particularly, the production yield of the solid state imaging device largely affects the cost of a digital camera. Therefore, it is preferable to employ a solid state imaging device which can enhance the production yield.

In a solid state imaging device in which pixels are highly miniaturized, a color filter, a planarizing film, a microlens, and the like must be stacked above light receiving portions which are formed in the surface of a semiconductor substrate, and hence the distance (the height of each pixel) between the light receiving portions and the microlens (top lens) cannot be shortened. By contrast, in a solid state imaging device which has a large number of pixels, the size of an opening of each pixel is reduced to the order of the wavelength of incident light, and hence the incident optical path of each pixel between the top lens and a photoelectrical converting element is formed as a long and thin passage. Moreover, the incident angle in a peripheral portion of the solid state imaging device is more oblique than that in a central portion. In order to avoid insufficiency of the light amount, i.e., color shading in the peripheral portion, therefore, a color filter, a planarizing film, a microlens, and the like for pixels of the peripheral portion must be stacked so that each incident optical path is inclined in accordance with the incident angle. This constitutes a cause of a reduced production yield of a solid state imaging device.

A related-art triple-type solid state color image pickup apparatus exerts high color reproducibility and has a high sensitivity, but uses a complex and large color separation prism and three solid state imaging devices. Therefore, such an apparatus has problems in that the production cost is increased, and that the apparatus can be mounted only on a large digital camera.

A related-art dual-type solid state color image pickup apparatus has a configuration in which one of the three primary colors is reflected by a prism, and the other two colors are separated from each other by a color filter, and hence has a problem in that the sensitivity is inferior to that of a triple-type apparatus. Since a solid state imaging device in which the color filter is formed and the production yield is low is used, such an apparatus has a further problem in that the production cost is high.

A related-art single-type solid state color image pickup apparatus which uses a color filter has problems in that the production cost is raised because a solid state imaging device of a low production yield is used, and that the sensitivity is poor because, in incident light, light of a color which is not used is cut off by the color filter.

A related-art single-type solid state color image pickup apparatus which does not use a color filter is configured so that separation and detection of the three primary colors are conducted with using the optical property of a semiconductor. Therefore, such an apparatus has a problem in that the color separability is not sufficient and color reproduction of a picked-up image is hardly conducted. Since the three primary colors are separated from one another in one pixel, it is difficult to produce such an apparatus. In the CMOS image sensor described above, particularly, large-scale wiring must be formed between pixels and peripheral circuits, thereby causing another problem in that the area of a light receiving portion region is reduced.

### SUMMARY OF THE INVENTION

It is an object of the invention to provide a dual-type solid state color image pickup apparatus that uses solid state imaging devices on which a color filter is not mounted, and in which the production yield is therefore improved, whereby miniaturization of the apparatus, and color reproducibility and high sensitivity of a triple-type apparatus can be realized, and also to provide a digital camera on which such an apparatus is mounted.

According to the invention, there is provided a dual-type solid state color image pickup apparatus comprising: a color separation prism that separates incident light from an object into first and second colors, and a third color of three primary colors; a first solid state imaging device that receives incident light of the separated first and second colors that is separated by the color separation prism; and a second solid state imaging device that receives incident light of the third color that is separated by the color separation prism, wherein each of a plurality of first sampling points in a two-dimensional plane of a first image signal corresponding to the first color is identical with each of a plurality of second sampling points in a two-dimensional plane of a second image signal corresponding to the second color, the first and second image signals being detected by the first solid state imaging device.

According to the configuration, the color separation prism can be configured in a simplified manner, and a reduced production cost and miniaturization can be realized. Moreover, it is possible to pick up an image of a high quality and high sensitivity which are equivalent to those obtained by a triple-type apparatus. Furthermore, a color moire and a false color can be reduced.

According to the invention, there is provided the dual-type solid state color image pickup apparatus, wherein each of a plurality of third sampling points in a two-dimensional plane of a third image signal corresponding to the third color is identical with each of said plurality of first or second sampling points, the third image signal being detected by the second solid state imaging device.

According to the configuration, it is possible to further avoid generation of a color moire and a false color.

According to the invention, there is provided a dual-type solid state color image pickup apparatus comprising: a color separation prism that separates incident light from an object into first and second colors, and a third color of three primary colors; a first solid state imaging device that receives incident light of the separated first and second colors that is separated by the color separation prism; and a second solid state imaging device that receives incident light of the third color that is separated by the color separation prism, wherein first light receiving portions, formed in an array pattern in the first solid state imaging device, for receiving light of the first and second colors are equal in number to second light receiving portions, formed in an array pattern in the second solid state imaging device, for receiving light of the third color.

According to the configuration, the color separation prism can be configured in a simplified manner, and a reduced production cost and miniaturization can be realized. Moreover, it is possible to pick up an image of a high quality and high sensitivity which are equivalent to those obtained by a triple-type apparatus. Furthermore, a color moire and a false color can be reduced.

According to the invention, there is provided a dual-type solid state color image pickup apparatus comprising: a color separation prism that separates incident light from an object into first and second colors, and a third color of three primary colors; a first solid state imaging device that receives incident light of the separated first and second colors that is separated by the color separation prism; and a second solid state imaging device that receives incident light of the third color that is separated by the color separation prism, wherein each of a plurality of first light receiving portions, formed in the first solid state imaging device, outputs (i) a corresponding first pixel signal of a plurality of first pixel signals by which a first image signal is generated and (ii) a corresponding second pixel signal of a plurality of second pixel signals by which a second image signal is generated.

According to the configuration, the color separation prism can be configured in a simplified manner, and a reduced production cost and miniaturization can be realized. Moreover, it is possible to pick up an image of a high quality and high sensitivity which are equivalent to those obtained by a triple-type apparatus. Furthermore, a color moire and a false color can be reduced.

According to the invention, there is provided the dual-type solid state color image pickup apparatus, wherein the first solid state imaging device further comprises first light receiving portions formed in a semiconductor substrate of the first solid state imaging device; each of the first light receiving portions includes: a first-color detecting high-concentration impurity layer that detects a corresponding first pixel signal of a plurality of first pixel signals by which the first image signal is generated, the corresponding first pixel signal being in accordance with corresponding amount of incident light of the first color; and a second-color detecting high-concentration impurity layer, formed at a depth different from a depth of the first-color detecting high-concentration impurity layer, that detects a corresponding second pixel signal of a plurality of second pixel signals by which the second image signal is generated, the corresponding second pixel signal being in accordance with corresponding amount of incident light of the second color.

According to the configuration, the color separation prism can be configured in a simplified manner, and a reduced production cost and miniaturization can be realized. Moreover, it is possible to pick up an image of a high quality and high sensitivity which are equivalent to those obtained by a triple-type apparatus. Furthermore, a color moire and a false color can be reduced.

According to the invention, there is provided the dual-type solid state color image pickup apparatus, wherein the first color is blue, the second color is red, and the third color is green, the first-color detecting high-concentration impurity layer is formed in a surface portion of the semiconductor substrate of the first solid state imaging device, the second-color detecting high-concentration impurity layer is formed in a portion of the semiconductor substrate of said first solid state imaging device, the portion being deeper than the first-color detecting high-concentration impurity layer, and a third-color detecting high-concentration impurity layer which is formed in the second solid state imaging device, and which detects a corresponding third pixel signal of a plurality of third pixel signals by which the third image signal is generated, the corresponding third pixel signal being in accordance with corresponding amount of incident light of the third color, is formed at a depth intermediate between depths of the first-color detecting high-concentration impurity layer and the second-color detecting high-concentration impurity layer.

According to the configuration, color separability for the first and second colors output from the first solid state imaging device can be enhanced, and the first solid state imaging device can be easily produced.

According to the invention, there is provided the dual-type solid state color image pickup apparatus, wherein each of the first and second solid state imaging devices is configured by: one of a charge-coupled device (CCD); and a MOS image sensor. According to the invention, there is provided the dual-type solid state color image pickup apparatus, wherein the first solid state imaging device further comprises first light receiving portions; the second solid state imaging device further comprises second light receiving portions; the first light receiving portions are arranged in a honeycomb pattern; and the second light receiving portions are arranged in a honeycomb pattern.

According to the invention, there is provided a color separation prism for a dual-type solid state color image pickup apparatus which separates incident light from an object into first and second colors, and a third color of the three primary colors, which causes incident light of the first and second colors to be incident on a first solid state imaging device, and which causes incident light of the third color to be incident on a second solid state imaging device, the color separation prism comprising: a first prism member that reflects the incident light of the first and second colors, thereby causing the incident light to be incident on the first solid state imaging device; and a second prism member that reflects the incident light of the third color, thereby causing the incident light to be incident on the second solid state imaging device.

According to the configuration, the color separation prism can be configured in a small size and a reduced thickness.

In the dual-type solid state color image pickup apparatus of the invention, the above-mentioned color separation prism is used as the color separation prism.

According to the configuration, the size and thickness of the dual-type solid state color image pickup apparatus can be reduced.

According to the invention, there is provided a digital camera comprising the above-mentioned dual-type solid state color image pickup apparatuses.

According to the configuration, the size and thickness of the digital camera can be reduced, and the quality and sensitivity of a picked-up image can be enhanced.

### BRIEF DESCRIPTION OF THE DRAWINGS

FIG. 1 is a block diagram schematically showing the configuration of a digital still camera of an embodiment of the invention;

FIG. 2 is a diagram showing the configuration of a dual-type CCD module shown in FIG. 1;

FIG. 3 is a graph showing spectral characteristics of a color separation prism shown in FIG. 2;

FIG. 4 is a diagram of the surface of a first CCD shown in FIG. 2;

FIG. 5 is an enlarged view of four pixels in the first CCD shown in FIG. 4;

FIG. 6 is a section view taken along the line VI-VI of FIG. 5;

FIG. 7 is a diagram of the surface of a second CCD shown in FIG. 2;

FIG. 8 is a diagram of the surface of the second CCD shown in FIG. 7;

FIG. 9 is a section view taken along the line IX-IX of FIG. 8;

FIG. 10A is a view showing a potential profile of a light receiving portion shown in FIG. 6;

FIG. 10B is a view showing a potential profile of a light receiving portion shown in FIG. 9;

FIG. 11 is a diagram of the surface of a first CCD in a second embodiment of the invention;

FIG. 12 is a diagram of the surface of a second CCD in the second embodiment of the invention;

FIG. 13 is an enlarged view of four pixels in the first CCD shown in FIG. 11;

FIG. 14 is an enlarged view of four pixels in the second CCD shown in FIG. 12;

FIG. 15 is an enlarged view of the circle XV in FIG. 13 or 14;

FIG. 16 is a diagram of the surface of a first CMOS image sensor in a third embodiment of the invention;

FIG. 17 is a section diagram taken along the line XVII-XVII of FIG. 16;

FIG. 18 is a diagram of the surface of a second CMOS image sensor in the third embodiment of the invention;

FIG. 19 is a section diagram taken along the line XIX-XIX of FIG. 18;

FIG. 20 is an equivalent circuit diagram of amplifiers shown in FIGS. 17 and 19;

FIG. 21 is a plan diagram of one pixel shown in FIG. 16;

FIG. 22 is a plan diagram of one pixel shown in FIG. 18;

FIG. 23 is a diagram showing the configuration of a related-art triple-type solid state color image pickup apparatus;

FIG. 24 is a diagram showing the configuration of a related-art dual-type solid state color image pickup apparatus;

FIG. 25 is a plan view of a color filter used in a related-art single-type solid state color image pickup apparatus;

FIG. 26 is a section diagram of one light receiving portion of a related-art single-type solid state color image pickup apparatus in which a color filter is not used; and

FIG. 27 is a graph showing spectral characteristics of the single-type solid state color image pickup apparatus shown in FIG. 26.

### DETAILED DESCRIPTION OF THE INVENTION

Hereinafter, embodiments of the invention will be described with reference to the accompanying drawings.

### First Embodiment

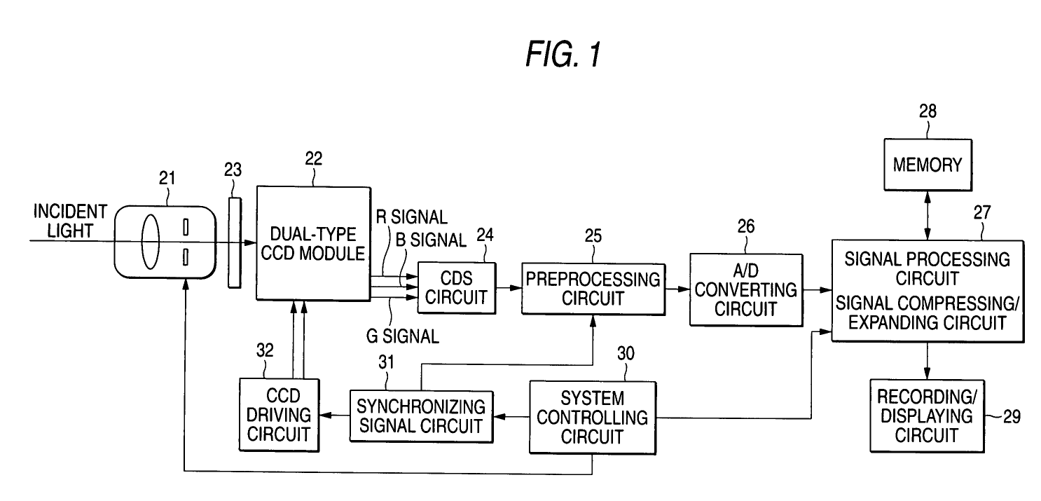

FIG. 1 is a block diagram schematically showing the configuration of a digital camera of an embodiment of the invention (in the embodiment, a digital still camera). The digital camera comprises: an optical system 21 on which a lens and an aperture for focusing incident light from an object are mounted; a dual-type CCD module 22 of the embodiment; and an infrared cutoff filter 23 which is placed between the optical system 21 and the module 22.

The digital camera of the embodiment further comprises: a CDS circuit 24 which receives red (R), blue (B), and green (G) signals output from the dual-type CCD module 22, and which applies processes such as correlation dual sampling on the signals; a preprocessing circuit 25 which receives an output signal of the CDS circuit 24, and which conducts a gain control process and the like; an A/D converting circuit 26 which converts analog R, G, and B signals output from the preprocessing circuit 25, to digital signals; a circuit 27 which receives R, G, and B image signals output from the A/D converting circuit 26, and which conducts signal processes such as white balance correction and gamma correction, and processes such as a process of compressing signals of a picked-up image and an expanding process; an image memory 28 connected to the circuit 27; and a recording/displaying circuit 29 which records picked-up image data processed by the circuit 27 into an external memory (not shown), and which displays the data on a liquid crystal display section disposed on the back face of the camera.

The digital camera further comprises: a system controlling circuit 30 which controls the whole digital camera; a synchronizing signal circuit 31 which generates a synchronizing signal in response to an instruction signal supplied from the system controlling circuit 30; and a CCD driving circuit 32 which supplies a driving signal to CCDs in the CCD module 22 on the basis of the synchronizing signal.

In the digital camera of the embodiment, the lens focusing and the aperture of the optical system 21 are controlled on the basis of an instruction signal supplied from the system controlling circuit 30, so that an optical image of the object is formed on two CCDs in the CCD module 22 via the optical system 21 and the infrared cutoff filter 23. Then, red (R), green (G), and blue (B) signals are output from the CCDs in accordance with the received optical image. The preprocessing circuit 25 controls the gains of the R, G, and B signals in accordance with the synchronizing signal, and the circuit 27 conducts signal processes and the like on the basis of instructions given from the system controlling circuit 30, whereby the picked-up image is reproduced based on the R, G, and B signals output from the CCD module 22 and image data compressed to data of a JPEG format or the like are recorded onto the external memory.

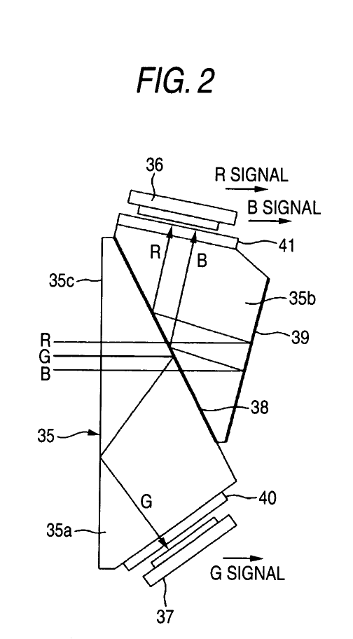

FIG. 2 is a diagram showing the configuration of the dual-type CCD module 22 shown in FIG. 1. The dual-type CCD module comprises: a color separation prism 35; and two CCDs or a first CCD 36 and a second CCD 37. The color separation prism 35 comprises: a first prism member 35a; a second prism member 35b; a green (G)-reflection dichroic film 38 which is formed between the members; and a total-reflection dichroic film 39 which is formed on an end face of the second prism member 35b. The film 39 is not necessary to be formed by a dichroic film, and may be formed by any kind of film as far as it can totally reflect incident light.

As shown in FIG. 2, the first prism member 35a has a triangular section shape, and comprises: a light incident face 35c which incident light enters substantially perpendicularly; an interface which is placed obliquely to the light incident face 35c, and on which the dichroic film 38 is vapor-deposited; and a third face to which the CCD 37 is opposed.

Also the second prism member 35b has a triangular section shape, and comprises: an interface which is in contact with the first prism member 35a (the dichroic film 38); a reflective face which is placed obliquely to the interface, and on which the total-reflection film 39 is vapor-deposited; and a third face to which the CCD 36 is opposed.

First, light from an object is perpendicularly incident on the light incident face 35c of the first prism member 35a. In the incident light, light of green (G) is reflected by the dichroic film 38, and then totally reflected by the light incident face 35c to be imaged onto the second CCD 37. Incident light of red (R) and blue (B) which has been transmitted through the first prism member 35a and the dichroic film 38 to be incident on the second prism member 35b is reflected by the total-reflection film 39, and then totally reflected by the interface of the first prism member 35a to be imaged onto the first CCD 36.

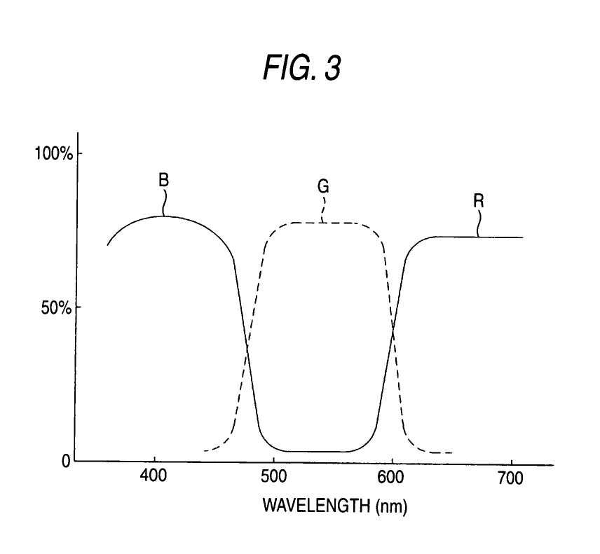

A green trimming filter film 40 is formed on one of the end faces of the first prism member 35a. The second CCD 37 is opposed to the end face. Therefore, only light of green (G) having the spectral characteristics indicated by the broken line in FIG. 3 is incident on the CCD 37. A red and blue trimming filter film 41 is formed on one of the end faces of the second prism member 35b. The first CCD 36 is opposed to the end face. Therefore, only light of red (R) and blue (B) having the spectral characteristics indicated by the solid line in FIG. 3 is incident on the CCD 36. The graph of FIG. 3 showing the spectral characteristics of R, G, and B is normalized by the peak of green (G).

In the embodiment, the trimming filters 40, 41 are disposed in addition to the dichroic films 38, 39 in order to further enhance the color separability for R, G, and B. The trimming filters 40, 41 may be omitted.

The color separation prism 35 of the embodiment shown in FIG. 2 is configured so that light of green (G) incident on the first prism member 35a is reflected two times and then imaged onto the second CCD 37, and light of red (R) and blue (B) incident on the second prism member 35b is reflected two times and then imaged onto the first CCD 36. Therefore, the image on the second CCD 37 is not formed as an image which is a mirror inversion of the image on the first CCD 36.

In the color separation prism 35 of the embodiment, the prism member 7b of FIG. 24 is not required, and hence the dimension in the direction of light incidence can be reduced. Therefore, the size, weight, and thickness of a CCD module can be reduced. In a CCD module which is to be mounted on a large digital camera, however, the prism shown in FIG. 24 may be used as the color separation prism.

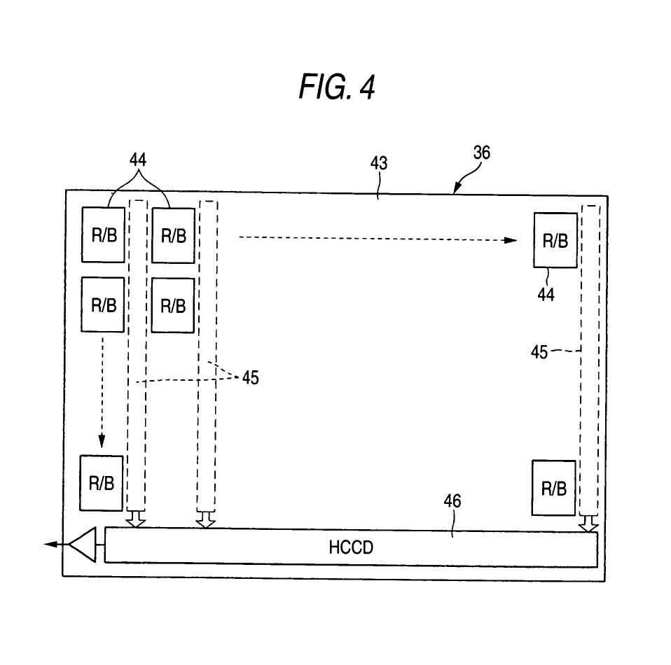

FIG. 4 is a diagram of the surface of the CCD 36. In the CCD 36, a large number of light receiving portions 44 (hereinafter, each of the light receiving portions is often referred to as “pixel”. In addition, a signal received by each of the light receiving portions is often referred to as “pixel signal”) which have a rectangular shape in the illustrated example are formed in the surface portion of a semiconductor substrate 43. The light receiving portions 44 are arranged so as to form a square lattice in the surface of the semiconductor substrate 43. A vertical transfer path 45 is formed on the right side of each column of the light receiving portions 44. A horizontal transfer path (HCCD) 46 which transfers in the horizontal direction signal charges that are read out from the light receiving portions 44 and then transferred through the vertical transfer paths 45 is formed in a lower-side portion of the semiconductor substrate 43.

In FIG. 4, “R/B” is indicated in each of the pixels 44. This means that, because of the section structure which will be described later, each of the pixels 44 of the CCD 36 has a function of separately detecting red (R) and blue (B) without using a color filter.

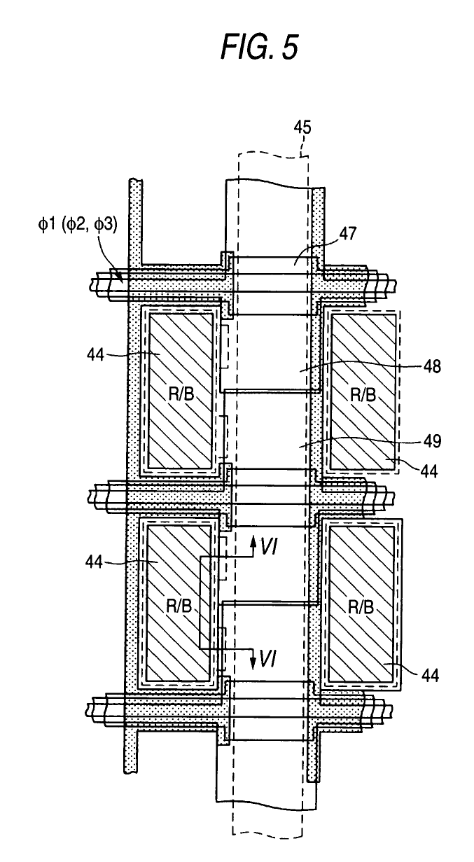

FIG. 5 is an enlarged view of four pixels in the light receiving portions 44 shown in FIG. 4, and shows transfer electrodes. The transfer electrodes 47, 48, 49 in the embodiment have a three-layer polysilicon structure to constitute an interline CCD in which all-pixel reading (progressive operation) is enabled. In the illustrated example, the third polysilicon electrode 49 functions also as a read gate electrode for reading out signal charges of blue (B), and the second polysilicon electrode 48 functions also as a read gate electrode for reading out signal charges of red (R).

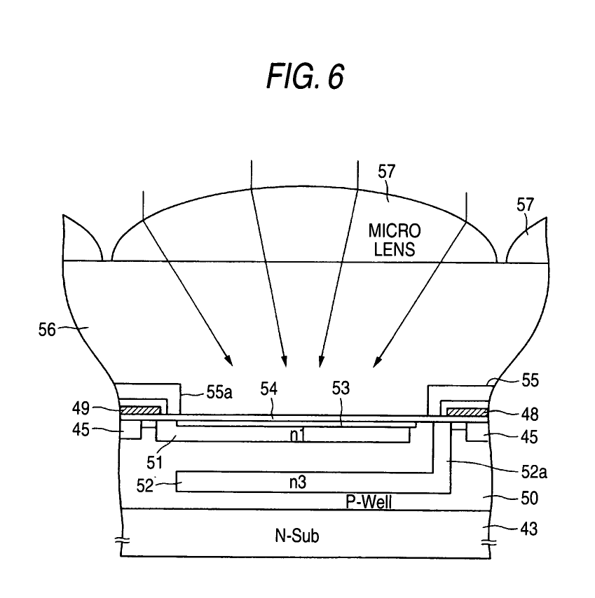

FIG. 6 is a section view taken along the line VI-VI of FIG. 5. In the CCD 36 in the embodiment, color signal components of R and B are separated from each other with using the optical property of a silicon substrate. Namely, the following property is used. The optical absorption coefficient of the silicon substrate is varied in the visible light region from long-wavelength light (R) to short-wavelength light (B). Therefore, light in a wavelength region where the optical absorption coefficient is large is absorbed by a shallow region of the silicon substrate and hardly reaches a deep portion of the silicon substrate. By contrast, light in a wavelength region where the optical absorption coefficient is small reaches a deep portion of the silicon substrate. Consequently, photoelectric conversion is enabled also in a deep portion of the silicon substrate.

Referring to FIG. 6, a P-well layer 50 is formed in the surface of an N-type semiconductor substrate 43. In the P-well layer 50, an N⁺ layer (n1) 51 is formed in a shallow portion, and an N⁺ layer (n3) 52 is formed in a deep portion so that the N⁺ layers are separated from each other in the depth direction.

Signal charges which are generated mainly by incident light components of short-wavelength light (B) are accumulated into the N⁺ layer 51 which is disposed in the shallowest position in the thickness direction of the semiconductor substrate 43. The N⁺ layer 51 (the impurity (P or As) concentration is about 5×10¹⁶ to 5×10¹⁷ atoms/cm³, and the depth is 0.2 to 0.5 μm (the depth depends also on the impurity concentration, and this is applicable also to the followings)) which forms the signal charge accumulating portion is elongated to extend beneath the read gate electrode 49. Therefore, only charges which are generated mainly by short-wavelength light (B) are read out to the vertical transfer path 45 through a gate.

An end portion of the N⁺ layer (n3) 52 which is formed in a deep portion has an N⁺ region (charge path) 52a which is raised to the surface of the semiconductor substrate 43. The N⁺ region 52a is elongated to extend beneath the read gate electrode 48 which is formed by a part of the transfer electrode. Signal charges which are generated by long-wavelength light (R) are accumulated into the N⁺ layer 52. The N⁺ layer 52 (the impurity concentration is about 5×10¹⁶ to 5×10¹⁷ atoms/cm³, and the depth is 1.0 to 2.5 μm) which forms the signal charge accumulating portion is elongated to extend beneath the read gate electrode 48. Therefore, charges which are generated mainly by long-wavelength light (R) are read out to the vertical transfer path 45 through a gate.

Preferably, a concentration gradient is formed so that the impurity concentration of the charge path 52a is higher than that of the accumulating portion 52 formed by the N⁺ layer. According to the configuration, signal charges can be easily read out from the accumulating portion 52 in the deep portion, and charges can be prevented from remaining unread.

A shallow P⁺ layer 53 is disposed in a part of the surface of the semiconductor substrate 43 where the two kinds of accumulating portions 51, 52 of different depths are disposed. An SiO₂ film 54 is disposed in the uppermost surface. In the P⁺ layer 53, the concentration of the impurity (boron) is about 1×10¹⁸ atoms/cm³, and the depth is about 0.1 to 0.2 μm. The P⁺ layer contributes to a reduced defect level of the interface between an oxide film and the semiconductor in the surface of each light receiving portion. Therefore, the accumulating portion 51 which is in the shallowest position in the depth direction of the semiconductor substrate 43 has a P⁺N⁺P structure. The boron concentration of the P region between the N⁺ layers 51, 52 is set to, for example, 1×10¹⁴ to 1×10¹⁶ atoms/cm³. The P region functions as a potential barrier between the accumulating portions 51, 52, whereby charges of the accumulating portions 51, 52 are blocked from being mixed with each other and the provability of color mixture is reduced.

On the upper surface of the SiO₂ film 54, the transfer electrodes 47, 48, 49 are formed in positions which avoid a light receiving region. A light shielding film 55 which has openings 55a in the light receiving region is disposed above the transfer electrodes. A planarizing film 56 is formed on the structure, and a top lens (microlens) 57 is formed on the planarizing film.

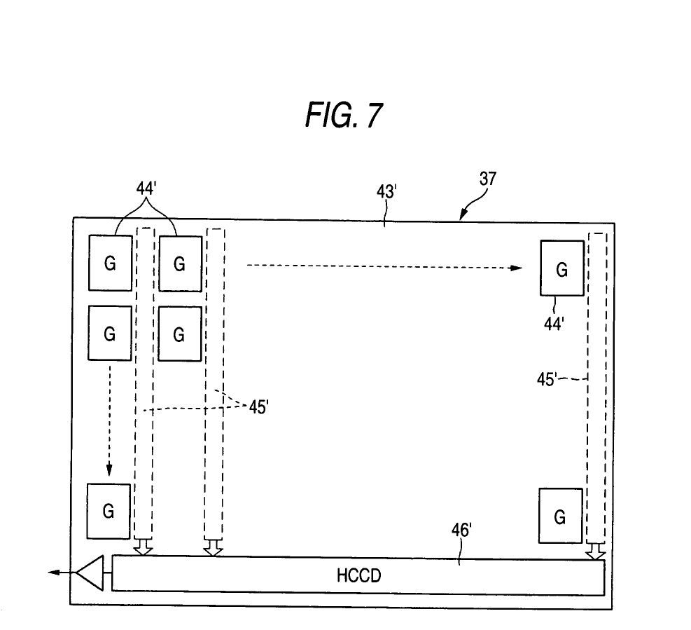

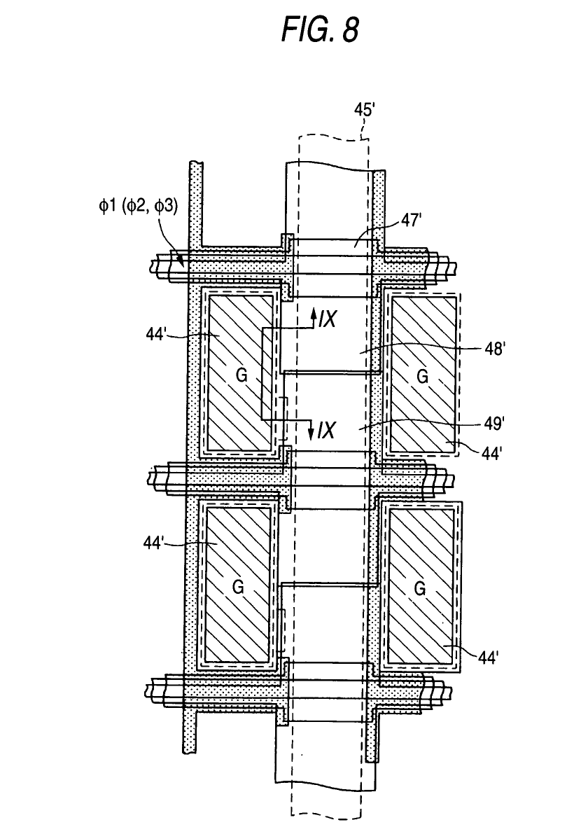

FIG. 7 is a diagram of the surface of the CCD 37, and FIG. 8 is an enlarged view of four pixels in light receiving portions. The CCD 37 is structured in a strictly identical manner as the CCD 36 except that light receiving portions 44′ have a section structure described later. Namely, the pixel numbers of the CCDs are equal to each other, and their pixel arrangements are identical to each other (in the illustrated example, a square lattice). Therefore, the components identical with those of the CCD 36 are denoted by the same reference numerals with “′” affixed thereto, and their description is omitted. In the same manner as the CCD 36, the CCD 37 is not provided with a color filter. The CCDs 36, 37 have pixels of the same number. This means that the CCDs are required only to have effective pixels the numbers of which are substantially equal to each other, and portions of ineffective pixels which do not receive light may not be identical with each other.

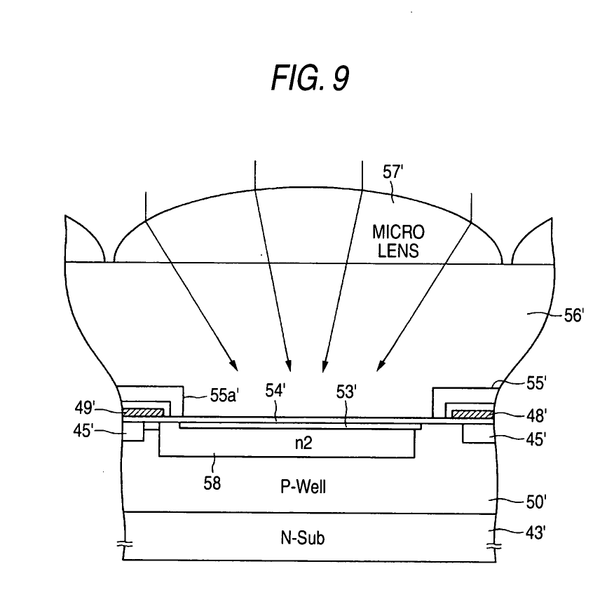

FIG. 9 is a section view taken along the line IX-IX of FIG. 8. A signal charge accumulating layer (n2) 58 formed by a single layer structure of an N⁺ layer is formed in a surface portion in the P-well layer 50′ formed in the surface of the N-type semiconductor substrate 43′. The depth of the accumulating layer 58 has an intermediate value between the depths of the accumulating layers 51, 52 of FIG. 6.

An end portion of the accumulating layer 58 is elongated to extend beneath a read gate electrode formed by a part of the transfer electrode 49′. Signal charges which are generated mainly by intermediate-wavelength light (G) are accumulated into the layer. In the N⁺ layer (n2) 58, for example, the impurity concentration is about 5×10¹⁶ to 5×10¹⁷ atoms/cm³, and the depth is about 0.5 to 1.5 μm.

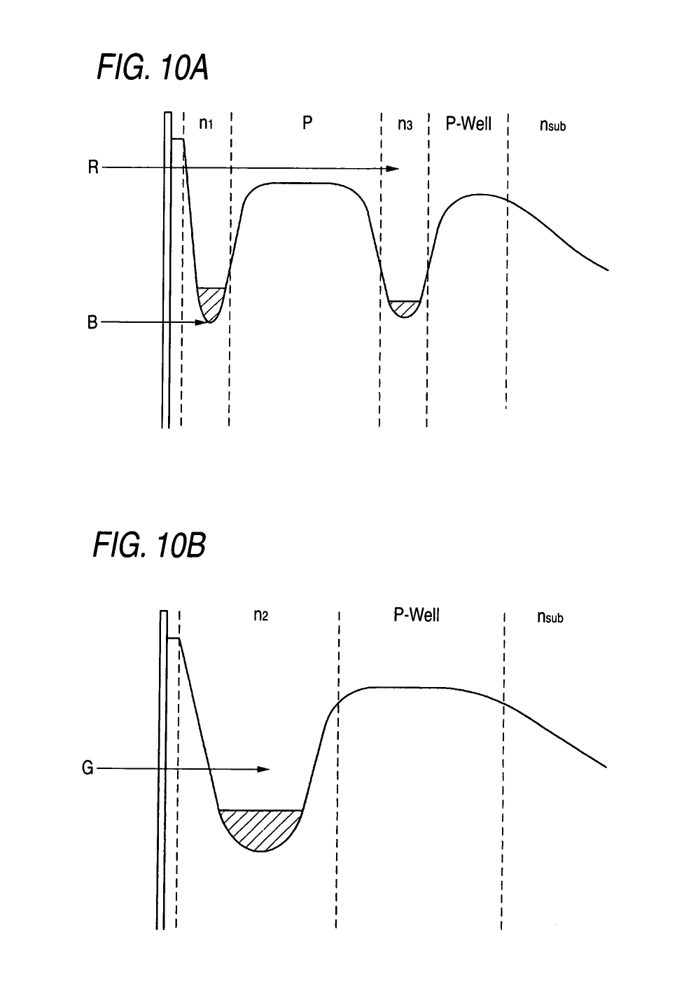

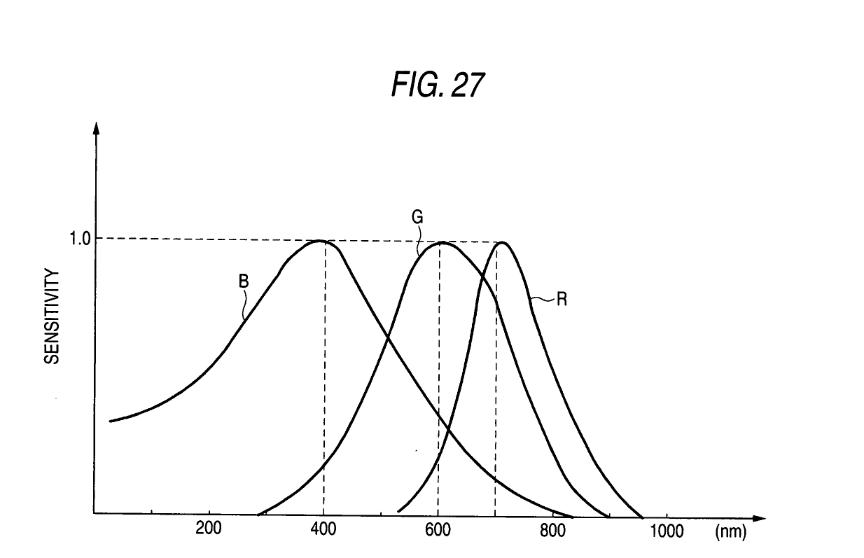

FIGS. 10A and 10B are views respectively showing potential profiles of the CCDs 36, 37. In the CCD 36 (FIG. 10A), light of B having the shortest wavelength is absorbed by the shallowest region of the silicon substrate to generate charges, and the charges are accumulated into the initial accumulating layer n1. Charges generated by light of R having the longest wavelength are accumulated into the accumulating layer n3 which is in the deepest portion of the silicon substrate. In this way, the CCD 36 separately detects red (R) and blue (B) with using the optical property of the silicon substrate. Since the color separation prism 35 shown in FIG. 2 is disposed so as to precede the CCD 36, only light of red (R) and blue (B) from which green (G) having an intermediate wavelength is previously eliminated, and which is indicated by the solid line in FIG. 3 is incident on the CCD 36. In the CCD 36, therefore, the color separabilities for red (R) and blue (B) are so high that gentle spectral characteristics such as shown in FIG. 27 are not caused even when the depths of the accumulating portions 51, 52 are not strictly controlled. Consequently, a high-performance CCD can be easily produced.

In the CCD 37 (FIG. 10B), green (G) is detected by the above-described section structure with using the optical property of the silicon substrate. Because of the color separation prism 35 shown in FIG. 2, only light of green (G) from which red (R) having a long wavelength and blue (B) having a short wavelength are previously eliminated, and which is indicated by the broken line in FIG. 3 is incident on the CCD. In the CCD 37, therefore, the color separability for green is so high that gentle spectral characteristics such as shown in FIG. 27 are not caused even when the depth of the accumulating portion 58 is not strictly controlled.

In the dual-type CCD of the embodiment, therefore, it is possible to attain the same color separability as that of a triple-type CCD. In the same manner as in a triple-type CCD, at the same sampling point, the R and B signals, and the G signal are simultaneously obtained from the CCD 36, and the CCD 37, respectively, and hence high-resolution image data can be obtained. Moreover, a synchronizing process is not necessary, and hence the signal processing load in the image processing is reduced.

In the same manner as a triple-type CCD, furthermore, it is possible to use all of incident light, and hence high sensitivity can be attained. As shown in FIG. 2, the length of the color separation prism in the traveling direction of the incident light from an object can be shortened, and hence reduction of the thickness and size of the digital camera can be attained. Since an economical color separation prism can be used, also the production cost can be reduced.

### Second Embodiment

In the above, the embodiment having the CCDs in which pixels are arranged in a square lattice has been exemplarily described. Alternatively, the invention may be realized also by using CCDs having the so-called honeycomb pixel arrangement in which rows of pixels of each CCD are shifted by a distance equal to about one half of the pitch as disclosed in JP-10-136391.

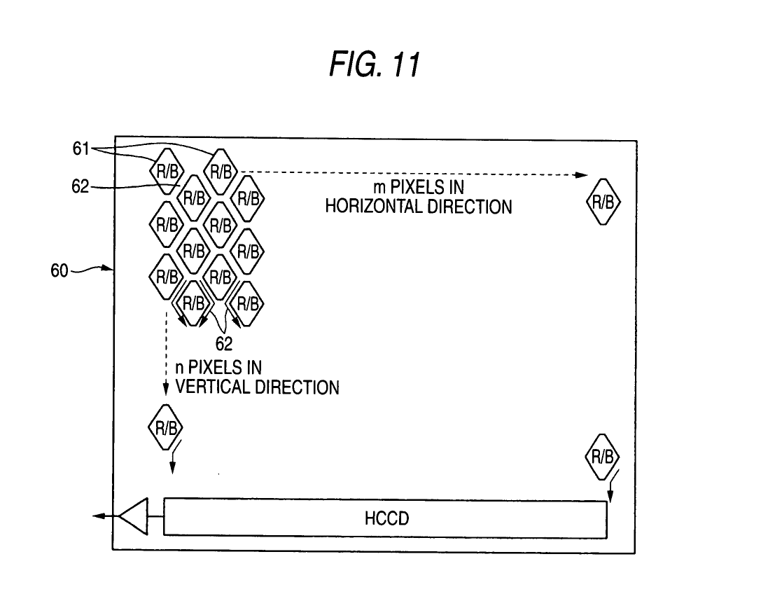

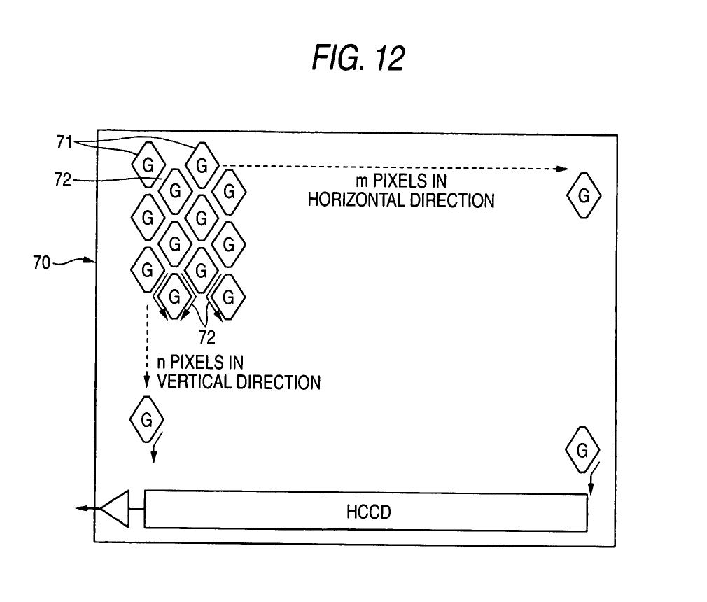

FIG. 11 is a diagram of the surface of a first CCD 60 having the honeycomb pixel arrangement, and FIG. 12 is a diagram of the surface of a second CCD 70 having the honeycomb pixel arrangement. Pixels 61 disposed in the CCD 60 have the same section structure as that of FIG. 6, so that color signals of red (R) and blue (B) are detected by each pixel without using a color filter. The rows of the pixels 61 are shifted by a distance equal to about one half of the pitch. A vertical transfer path 62 is placed in a meandering manner between the pixels 61 which are adjacent to each other in the horizontal direction. The; CCD 70 which detects the color signal of green (G) without using a color filter has the same section structure as that of FIG. 9. A vertical transfer path 72 is placed in a meandering manner between pixels 71 which are adjacent to each other in the horizontal direction. The pixels 71 detect the color signal of green (G).

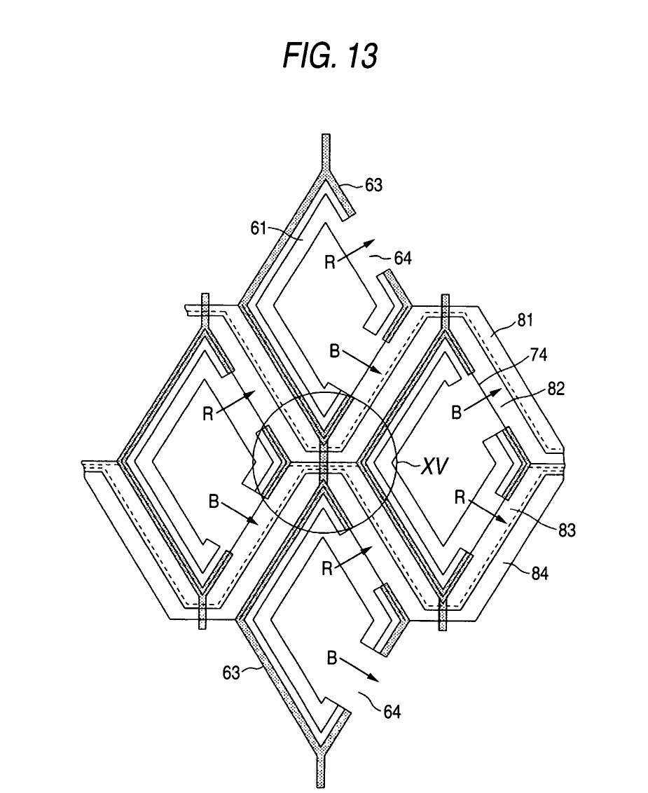

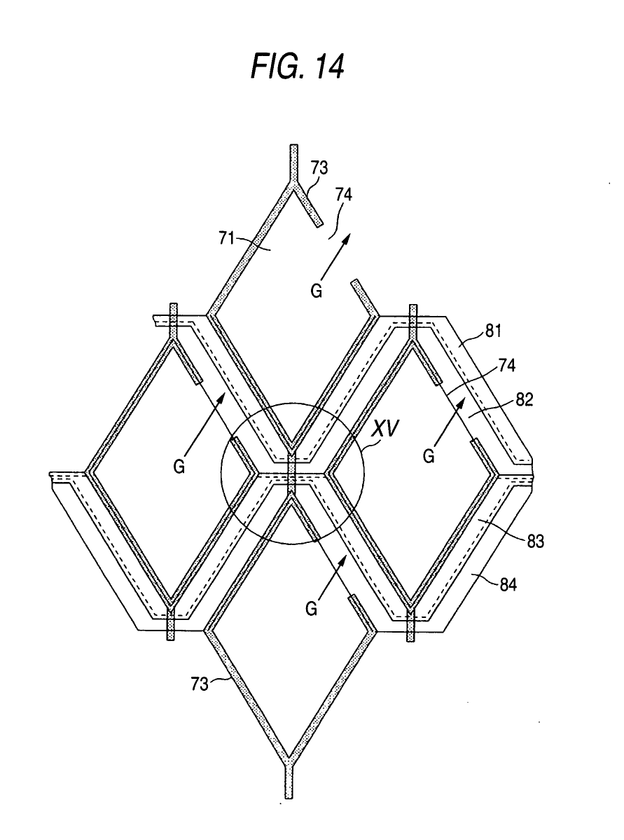

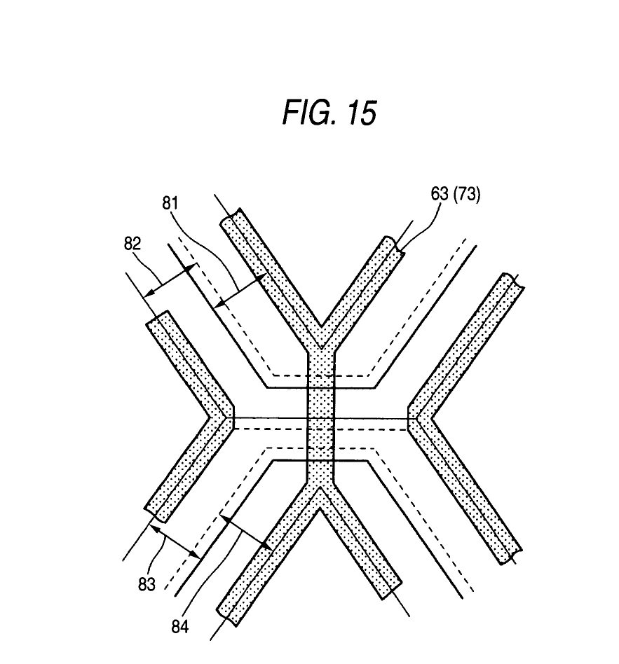

FIG. 13 is an enlarged view of four pixels in the CCD 60, and FIG. 14 is an enlarged view of four pixels in the CCD 70. FIG. 15 is a detail view showing transfer electrodes in the circle XV in FIG. 13 or 14. The pixels 61 or 71 are defined by element isolation zones 63 or 73 which are formed into a rhombus shape. Signal charges are read out to the vertical transfer paths 62 or 72 between the pixels, through gates 64 or 74 disposed in the element isolation zones 63 or 73. Transfer electrodes having a two-layer polysilicon structure are stackingly disposed above the vertical transfer paths 62 or 72, so that four transfer electrodes 81, 82, 83, 84 correspond to each pixel. According to the configuration, the CCD having the honeycomb pixel arrangement is formed as a CCD in which the all-pixel reading (progressive operation) can be conducted by the transfer electrodes having a two-layer polysilicon structure.

Also in the configuration in which the two CCDs 60, 70 having pixels of the same number and the honeycomb pixel arrangement are used as in the second embodiment, the same effects as those of the first embodiment can be attained. Since the CCDs having the honeycomb pixel arrangement are used, the number of pixels can be further increased as compared with the first embodiment. Moreover, the progressive operation is enabled by the transfer electrodes having a two-layer polysilicon structure, and hence reduction of the production cost and improvement of the production yield can be realized.

### Third Embodiment

In the above, the embodiments in which the CCDs are used as solid state imaging devices have been exemplarily described. Alternatively, the invention may be realized also by using solid state imaging devices of another kind, such as CMOS image sensors.

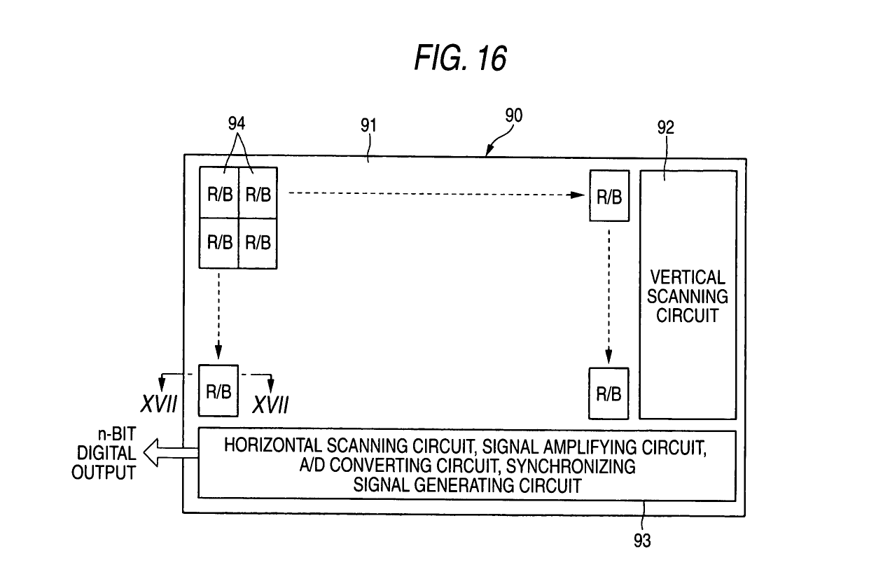

FIG. 16 is a diagram of the surface of a first CMOS image sensor. The first CMOS image sensor 90 comprises: a vertical scanning circuit 92 which is formed in the surface portion of an N-type semiconductor substrate 91, and which is formed at the side of a light receiving region; and circuits 93 such as a horizontal scanning circuit (a signal amplifying circuit, an A/D converting circuit, a synchronizing signal generating circuit, and the like) which are formed in the base edge side of the semiconductor substrate 91.

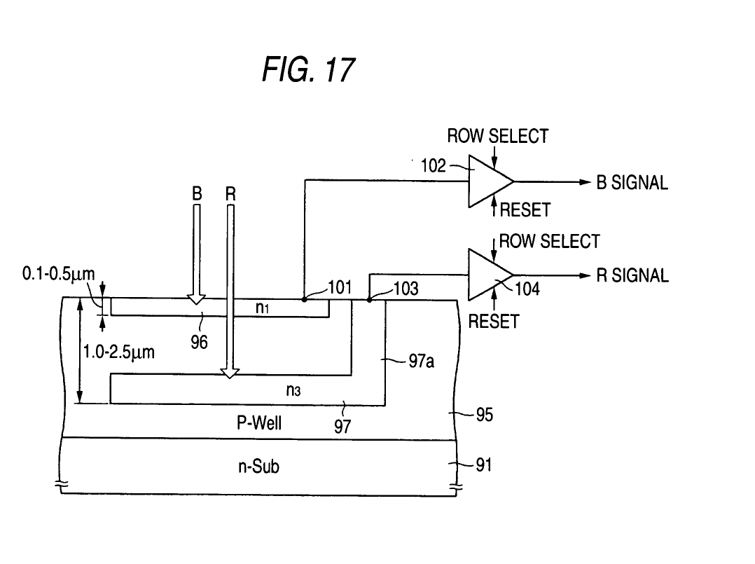

In the light receiving region, a large number of light receiving portions 94 are arranged in a two-dimensional array or a square lattice in this example. FIG. 17 is a section diagram taken along the line XVII-XVII of FIG. 16. In the same manner as the above-described embodiments, a color filter is not mounted on the first CMOS image sensor 90. As shown in FIG. 17, incident light of green (G) is eliminated as a result of passing through the color separation prism 35 shown in FIG. 2, and only incident light of blue (B) and red (R) reaches the light receiving portions 94 of the first CMOS image sensor 90.

In each of the light receiving portions 94, a P-well layer 95 is formed in the surface of an N-type semiconductor substrate 91. In the P-well layer 95, an N⁺ layer (n1) 96 of a thickness of 0.1 to 0.5 μm is formed in the surface, and an N⁺ layer (n3) 97 of a thickness of 1.0 to 2.5 μm is formed in a deep portion so as to be separated from the N⁺ layer 96. In the N⁺ layer 97, a charge path 97a which is raised from the end portion to the surface is disposed.

In the embodiment, the impurity (P or As) concentrations of the N⁺ layers 96, 97, 97a are set to about 5×10¹⁶ to 5×10¹⁷ atoms/cm³. The depths of the N⁺ layers 96, 97 depend also on the respective impurity concentrations.

A P region functioning as a potential barrier is formed between the N⁺ layers 96, 97. The potential of the P region is kept to be equal to that of the P-well layer 95. In order to change the height of the potential barrier, the impurity (boron) concentration (1×10¹⁵ to 1×10¹⁶ atoms/cm³) of the P region between the N⁺ layers 96, 97 may be different from the impurity concentration (7×10¹⁴ to 7×10¹⁵ atoms/cm³) of the P-well layer 95.

The N⁺ layer 96 is connected through an ohmic contact 101 to a B-signal detection amplifier 102, and the charge path 97a of the N⁺ layer 97 is connected through an ohmic contact 103 to an R-signal detection amplifier 104. In order to satisfactorily attain the ohmic contacts 101, 103, the contact portions of the N⁺ layers 96, 97a are set to have an impurity concentration of, in this example, 1×10¹⁹ atoms/cm³ or more.

According to this section structure of the light receiving portion, a reset transistor is turned ON before a process of picking up a color image, and charges of a predetermined amount are accumulated in the PN junction of each of the N⁺ layers 96, 97. The charges accumulated in the PN junction of the N⁺ layer 96 are discharged by an amount corresponding to photocarriers which are generated in accordance with the amount of the incident light of blue (B) that reaches the light receiving portion. The charges accumulated in the PN junction of the N⁺ layer 97 are discharged by an amount corresponding to photocarriers which are generated in accordance with the amount of incident light of red (R). The variations of charges in the PN junctions of the N⁺ layers 96, 97 are independently read out as the B and R signals by the amplifiers 102, 104.

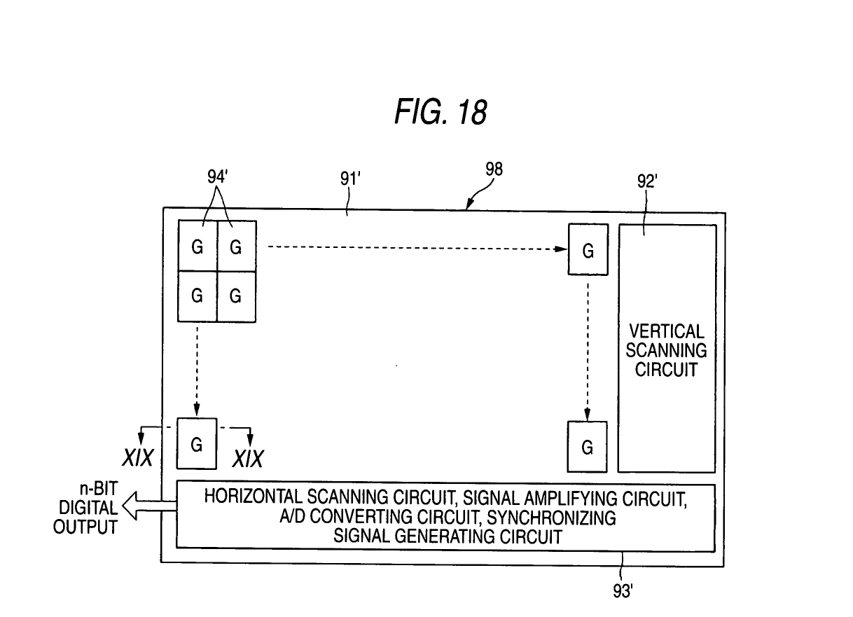

FIG. 18 is a diagram of the surface of a second CMOS image sensor. The second CMOS image sensor 98 is structured in a strictly identical manner as the first CMOS image sensor 90 except that light receiving portions 94′ have a section structure described later. A color filter is not mounted on the second CMOS image sensor. Therefore, the components identical with those of the first CMOS image sensor 90 are denoted by the same reference numerals with “′” affixed thereto, and their description is omitted.

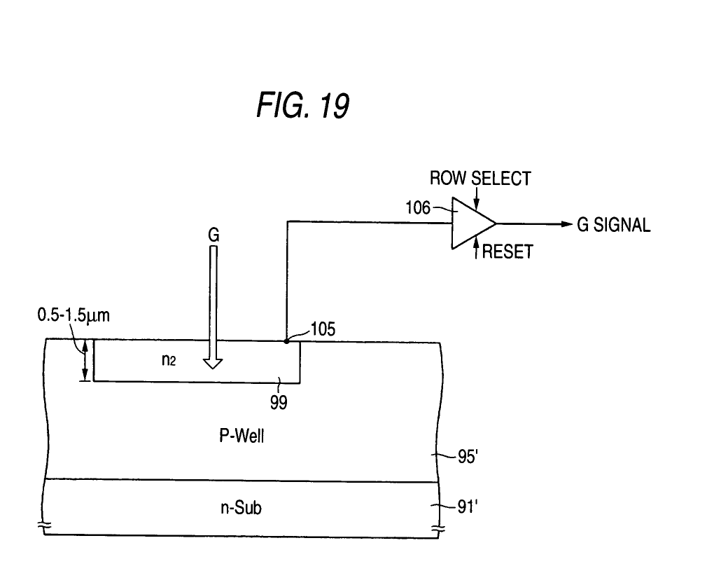

FIG. 19 is a section diagram taken along the line XIX-XIX of FIG. 18. As shown in FIG. 19, incident light of blue (B) and red (R) is eliminated as a result of passing through the color separation prism 35 shown in FIG. 2, and only incident light of green (G) reaches the light receiving portions 94′ of the second CMOS image sensor 98.

In each of the light receiving portions 94′, a P-well layer 95′ is formed in the surface of an N-type semiconductor substrate 91′, and an N⁺ layer (n2) 99 of a thickness of 0.5 to 1.5 μm is formed in the surface of the P-well layer 95′.

The N⁺ layer 99 is connected through an ohmic contact 105 to a G-signal detection amplifier 106. The impurity concentrations of the N⁺ layer 99 and the ohmic contact portions are equal to those which have been described with reference to FIG. 17. Although not illustrated in FIGS. 17 and 19, a light shielding film, a planarizing film, and a microlens are stacked also in the first and second CMOS image sensors 90 and 98.

According to this section structure of the light receiving portion, a reset transistor is turned ON before a process of picking up a color image, and charges of a predetermined amount are accumulated in the PN junction of the N⁺ layer 99. The charges accumulated in the PN junction of the N⁺ layer 99 are discharged by an amount corresponding to photocarriers which are generated in accordance with the amount of the incident light of green (G) that reaches the light receiving portion. The variation of charges is read out by the G-signal detection amplifier 106.

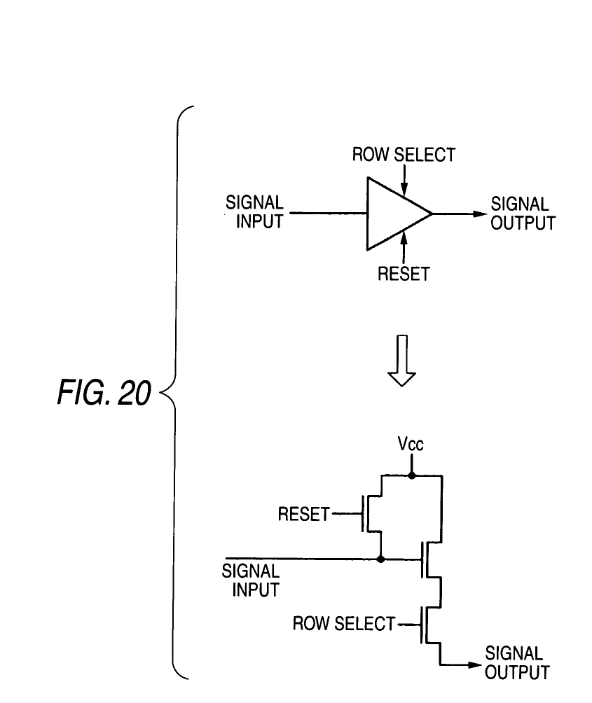

FIG. 20 shows an equivalent circuit of the amplifiers 102, 104, 106. Although not illustrated in FIGS. 17 and 19, the uppermost surface of the semiconductor substrate other than the contact portions is covered by a protective SiO₂ film. In the light receiving portions in FIGS. 17 and 19, the potential profile concept in the depth direction of the substrate is approximately identical in shape with FIGS. 10A and 10B, so that the red (G) and blue (B) signals are separated from each other.

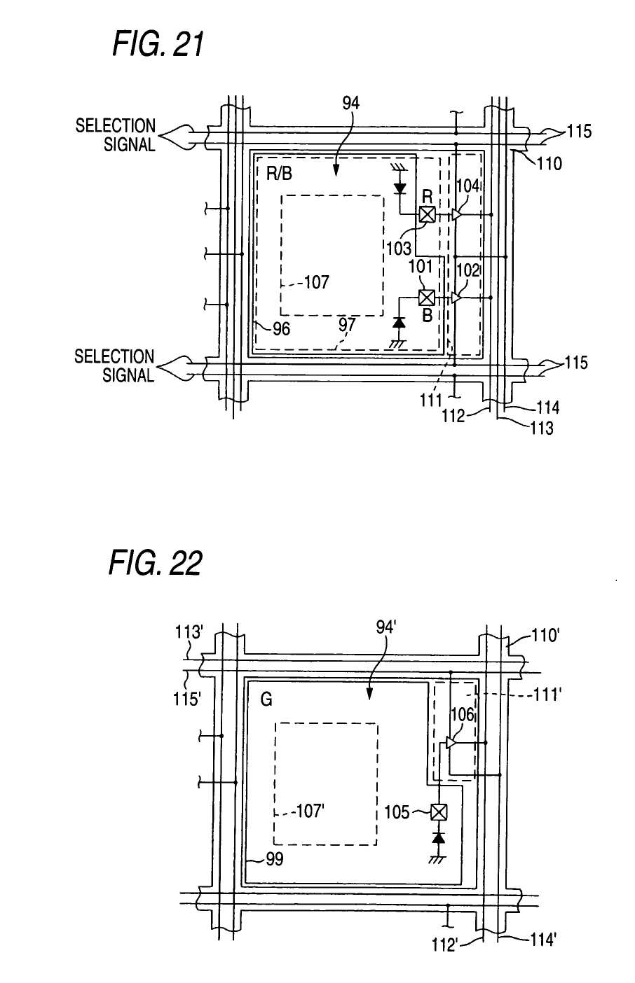

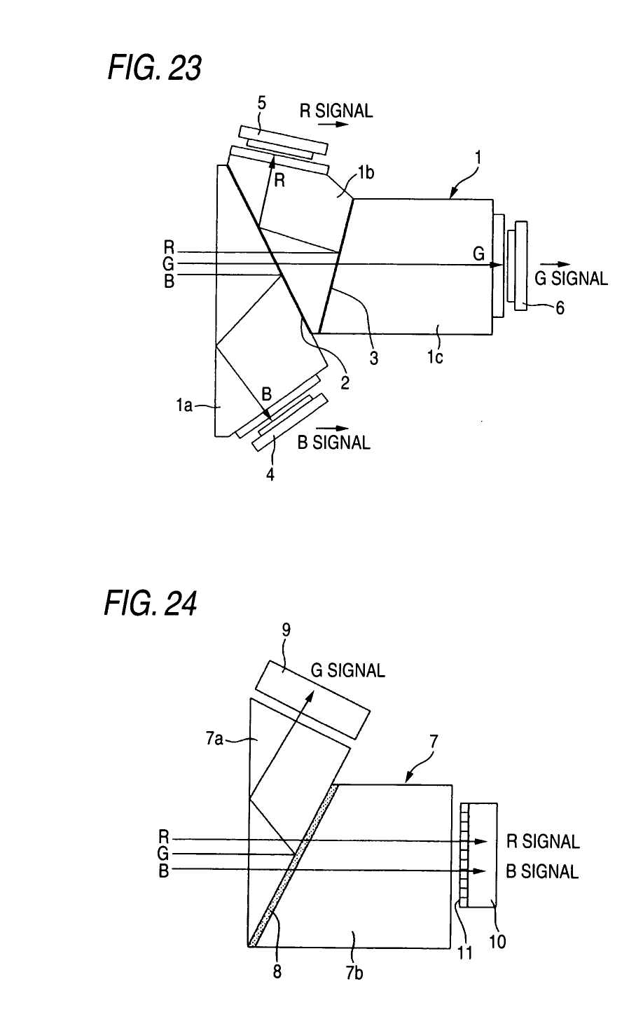

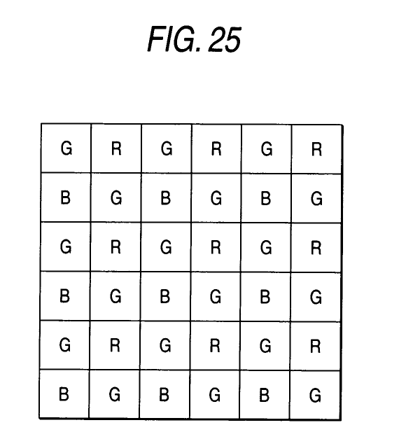

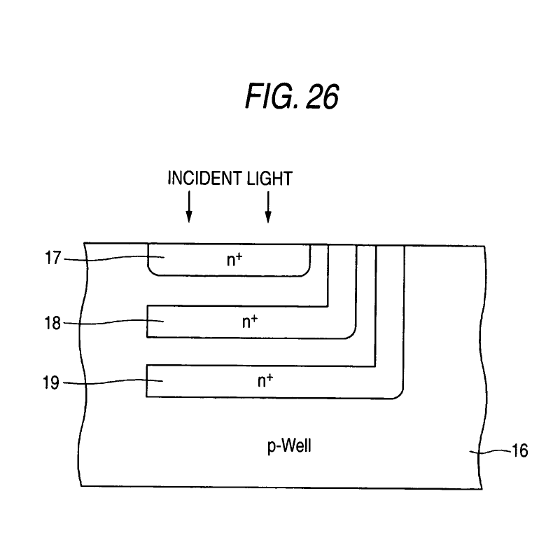

FIG. 21 is a two-dimensional plan view corresponding to one pixel of the first CMOS image sensor 90. In the surface of the semiconductor substrate 91, the light receiving portions 94 are isolated from each other so as to form a grid-like pattern, by element isolation zones 110 which elongate vertically and horizontally, and which are formed by LOCOS regions. In the illustrated example, each of the light receiving portions 94 has a substantially square shape.

In each of the light receiving portions, the N⁺ layers 96, 97 are formed in large part of the area, and a strip-like peripheral circuit portion 111 is disposed in the right end. The above-mentioned amplifiers (source-follower amplifiers) 102, 104 are disposed in the peripheral circuit portion 111. The color signals are read out respectively to the amplifiers from the N⁺ layers which are connected to the amplifiers through contact holes 101, 103 disposed in the light receiving portion.

A signal output line 112, a power source line 113, and a reset line 114 are laid on the element isolation zone 110 which elongates in the longitudinal direction in the figure, and two selection signal lines 115 are disposed on the element isolation zone 110 which elongates in the lateral direction. The signal output line 112 is connected to the outputs of the amplifiers 102, 104. A power source voltage is applied to the power source line 113, and a reset signal is applied to the reset line 114.

The selection signal and the reset signal are controlled by the circuits such as the vertical scanning circuit 92 and the horizontal scanning circuit 93 which are shown in FIG. 16. The broken-line frame 107 indicated on the light receiving portion shows the position of an opening of the light shielding film. Light passes only through the inside of the frame, and the outer side or the peripheral circuit portion 111 and the contact holes 101, 103 are shielded from light. As shown in the figure, the number of signal lines and peripheral circuits which must be disposed in one light receiving portion can be reduced.

In the solid state image pickup apparatus of the embodiment, therefore, the area of the light receiving portion can be widened, and hence it is possible to pick up a bright image.

FIG. 22 is a two-dimensional plan view corresponding to one pixel of the second CMOS image sensor 98. The image sensor is structured in a substantially same manner as the first CMOS image sensor 90. Therefore, the components identical with those of the first CMOS image sensor 90 are denoted by the same reference numerals with “′” affixed thereto, and their description is omitted.

In the second CMOS image sensor 98, the light receiving portion detects only one color signal, and hence the area of the peripheral circuit portion 111′ is one half of that of the peripheral circuit portion 111 of FIG. 21. Only one selection signal is required. In order to equalize the number of signal lines in the longitudinal direction with that of signal lines in the lateral direction, therefore, the power source line 113′ which elongates in the longitudinal direction in FIG. 21 is disposed in the lateral direction in FIG. 22.

Also when a dual-type solid state color image pickup apparatus is configured with using the first CMOS image sensor 90 and the second CMOS image sensor 98 in the embodiment, the same effects as those of the first and second embodiments can be attained.

In the third embodiment described above, the light receiving portions are arranged in a square lattice. It is a matter of course that it is possible to use CMOS image sensors having the so-called honeycomb pixel arrangement in which rows of light receiving portions are shifted by a distance equal to about one half of the pitch as disclosed in U.S. Pat. No. 4,558,365. The image sensors are not restricted to those of the CMOS type or the NMOS type, and MOS image sensors of another type may be used.

In each of the dual-type solid state color image pickup apparatuses of the embodiments described above, and a digital camera on which such an apparatus is mounted, it is possible to pick up a full-color image, and the size and cost of the image pickup apparatus can be reduced. Although the apparatus is a dual-type solid state image pickup apparatus, it is possible to pick up a color image of a high quality (high resolution, and without a color moire, a false color, and color shading) which is equivalent to that obtained by a triple-type solid state image pickup apparatus. Moreover, the power consumption can be further reduced as compared with the case of a triple-type apparatus.

Unlike a related-art single- or dual-type solid state color image pickup apparatus, a color filter is not used. Therefore, the energy of incident light can be effectively converted to an electric signal, and the sensitivity can be enhanced. In a CMOS solid state imaging device, particularly, the scale of a reading circuit which is placed in one pixel can be reduced, and the number of signal lines can be decreased. Therefore, a highly accurate focusing system (microlenses) can be easily formed on a chip so that the image quality and the sensitivity can be further improved.

According to the invention, the size and cost of the apparatus can be reduced, and a color reproducibility and high sensitivity which are equivalent to those obtained by a triple-type solid state color image pickup apparatus can be realized by the dual-type apparatus.

In the dual-type solid state color image pickup apparatus of the invention, it is possible to attain both reduction of the size and the cost, and improvement of the quality of a picked-up image. The dual-type solid state color image pickup apparatus is useful as an apparatus which is to be mounted on a digital camera such as a digital still camera or a digital video camera.

The entire disclosure of each and every foreign patent application from which the benefit of foreign priority has been claimed in the present application is incorporated herein by reference, as if fully set forth.

1. A dual-type solid state color image pickup apparatus comprising:
a color separation prism that separates incident light from an object into first and second colors, and a third color of three primary colors;
a first solid state imaging device that receives incident light of the separated first and second colors that is separated by the color separation prism; and
a second solid state imaging device that receives incident light of the third color that is separated by the color separation prism,
wherein each of a plurality of first sampling points in a two-dimensional plane of a first image signal corresponding to the first color is identical with each of a plurality of second sampling points in a two-dimensional plane of a second image signal corresponding to the second color, the first and second image signals being detected by the first solid state imaging device.

2. A dual-type solid state color image pickup apparatus according to claim 1, wherein each of a plurality of third sampling points in a two-dimensional plane of a third image signal corresponding to the third color is identical with each of said plurality of first or second sampling points, the third image signal being detected by the second solid state imaging device.

3. A dual-type solid state color image pickup apparatus comprising:
a color separation prism that separates incident light from an object into first and second colors, and a third color of three primary colors;
a first solid state imaging device that receives incident light of the separated first and second colors that is separated by the color separation prism; and
a second solid state imaging device that receives incident light of the third color that is separated by the color separation prism,
wherein first light receiving portions, formed in an array pattern in the first solid state imaging device, for receiving light of the first and second colors are equal in number to second light receiving portions, formed in an array pattern in the second solid state imaging device, for receiving light of the third color.

4. A dual-type solid state color image pickup apparatus comprising:
a color separation prism that separates incident light from an object into first and second colors, and a third color of three primary colors;
a first solid state imaging device that receives incident light of the separated first and second colors that is separated by the color separation prism; and
a second solid state imaging device that receives incident light of the third color that is separated by the color separation prism,
wherein each of a plurality of first light receiving portions, formed in the first solid state imaging device, outputs (i) a corresponding first pixel signal of a plurality of first pixel signals by which a first image signal is generated and (ii) a corresponding second pixel signal of a plurality of second pixel signals by which a second image signal is generated.

5. A dual-type solid state color image pickup apparatus according to claim 1,
wherein the first solid state imaging device further comprises first light receiving portions formed in a semiconductor substrate of the first solid state imaging device;
each of the first light receiving portions includes: a first-color detecting high-concentration impurity layer that detects a corresponding first pixel signal of a plurality of first pixel signals by which the first image signal is generated, the corresponding first pixel signal being in accordance with corresponding amount of incident light of the first color; and a second-color detecting high-concentration impurity layer, formed at a depth different from a depth of the first-color detecting high-concentration impurity layer, that detects a corresponding second pixel signal of a plurality of second pixel signals by which the second image signal is generated, the corresponding second pixel signal being in accordance with corresponding amount of incident light of the second color.

6. A dual-type solid state color image pickup apparatus according to claim 3,
wherein each of the first light receiving portions includes: a first-color detecting high-concentration impurity layer that detects a corresponding first pixel signal of a plurality of first pixel signals by which the first image signal is generated, the corresponding first pixel signal being in accordance with corresponding amount of incident light of the first color; and a second-color detecting high-concentration impurity layer, formed at a depth different from a depth of the first-color detecting high-concentration impurity layer, that detects a corresponding second pixel signal of a plurality of second pixel signals by which the second image signal is generated, the corresponding second pixel signal being in accordance with corresponding amount of incident light of the second color.

7. A dual-type solid state color image pickup apparatus according to claim 4,
wherein each of the first light receiving portions includes: a first-color detecting high-concentration impurity layer that detects a corresponding first pixel signal of a plurality of first pixel signals by which the first image signal is generated, the corresponding first pixel signal being in accordance with corresponding amount of incident light of the first color; and a second-color detecting high-concentration impurity layer, formed at a depth different from a depth of the first-color detecting high-concentration impurity layer, that detects a corresponding second pixel signal of a plurality of second pixel signals by which the second image signal is generated, the corresponding second pixel signal being in accordance with corresponding amount of incident light of the second color.

8. A dual-type solid state color image pickup apparatus according to claim 5, wherein the first color is blue, the second color is red, and the third color is green, the first-color detecting high-concentration impurity layer is formed in a surface portion of the semiconductor substrate of the first solid state imaging device, the second-color detecting high-concentration impurity layer is formed in a portion of the semiconductor substrate of said first solid state imaging device, the portion being deeper than the first-color detecting high-concentration impurity layer, and a third-color detecting high-concentration impurity layer which is formed in the second solid state imaging device, and which detects a corresponding third pixel signal of a plurality of third pixel signals by which the third image signal is generated, the corresponding third pixel signal being in accordance with corresponding amount of incident light of the third color, is formed at a depth intermediate between depths of the first-color detecting high-concentration impurity layer and the second-color detecting high-concentration impurity layer.

9. A dual-type solid state color image pickup apparatus according to claim 6, wherein the first color is blue, the second color is red, and the third color is green, the first-color detecting high-concentration impurity layer is formed in a surface portion of the semiconductor substrate of the first solid state imaging device, the second-color detecting high-concentration impurity layer is formed in a portion of the semiconductor substrate of said first solid state imaging device, the portion being deeper than the first-color detecting high-concentration impurity layer, and a third-color detecting high-concentration impurity layer which is formed in the second solid state imaging device, and which detects a corresponding third pixel signal of a plurality of third pixel signals by which the third image signal is generated, the corresponding third pixel signal being in accordance with corresponding amount of incident light of the third color, is formed at a depth intermediate between depths of the first-color detecting high-concentration impurity layer and the second-color detecting high-concentration impurity layer.

10. A dual-type solid state color image pickup apparatus according to claim 7, wherein the first color is blue, the second color is red, and the third color is green, the first-color detecting high-concentration impurity layer is formed in a surface portion of the semiconductor substrate of the first solid state imaging device, the second-color detecting high-concentration impurity layer is formed in a portion of the semiconductor substrate of said first solid state imaging device, the portion being deeper than the first-color detecting high-concentration impurity layer, and a third-color detecting high-concentration impurity layer which is formed in the second solid state imaging device, and which detects a corresponding third pixel signal of a plurality of third pixel signals by which the third image signal is generated, the corresponding third pixel signal being in accordance with corresponding amount of incident light of the third color, is formed at a depth intermediate between depths of the first-color detecting high-concentration impurity layer and the second-color detecting high-concentration impurity layer.

11. A dual-type solid state color image pickup apparatus according to claim 1, wherein each of the first and second solid state imaging devices is configured by a charge-coupled device (CCD).

12. A dual-type solid state color image pickup apparatus according to claim 3, wherein each of the first and second solid state imaging devices is configured by a charge-coupled device (CCD).

13. A dual-type solid state color image pickup apparatus according to claim 4, wherein each of the first and second solid state imaging devices is configured by a charge-coupled device (CCD).

14. A dual-type solid state color image pickup apparatus according to claim 1, wherein each of the first and second solid state imaging devices is configured by a MOS image sensor.

15. A dual-type solid state color image pickup apparatus according to claim 3, wherein each of the first and second solid state imaging devices is configured by a MOS image sensor.

16. A dual-type solid state color image pickup apparatus according to claim 4, wherein each of the first and second solid state imaging devices is configured by a MOS image sensor.

17. A dual-type solid state color image pickup apparatus according to claim 1,
wherein the first solid state imaging device further comprises first light receiving portions;
the second solid state imaging device further comprises second light receiving portions;
the first light receiving portions are arranged in a honeycomb pattern; and
the second light receiving portions are arranged in a honeycomb pattern.

18. A dual-type solid state color image pickup apparatus according to claim 3,
wherein the first light receiving portions are arranged in a honeycomb pattern; and
the second light receiving portions are arranged in a honeycomb pattern.

19. A dual-type solid state color image pickup apparatus according to claim 4,
wherein the first light receiving portions are arranged in a honeycomb pattern; and
the second light receiving portions are arranged in a honeycomb pattern.

20. A color separation prism for a dual-type-solid state color image pickup apparatus which separates incident light from an object into first and second colors, and a third color of the three primary colors, which causes incident light of the first and second colors to be incident on a first solid state imaging device, and which causes incident light of the third color to be incident on a second solid state imaging device,
the color separation prism comprising:
a first prism member that reflects the incident light of the first and second colors, thereby causing the incident light to be incident on the first solid state imaging device; and
a second prism member that reflects the incident light of the third color, thereby causing the incident light to be incident on the second solid state imaging device.

21. A dual-type solid state color image pickup apparatus comprising:
a color separation prism that separates incident light from an object into first and second colors, and a third color of three primary colors;
a first solid state imaging device that receives incident light of the separated first and second colors that is separated by the color separation prism; and
a second solid state imaging device that receives incident light of the third color that is separated by the color separation prism,
wherein each of a plurality of first sampling points in a two-dimensional plane of a first image signal corresponding to the first color is identical with each of a plurality of second sampling points in a two-dimensional plane of a second image signal corresponding to the second color, the first and second image signals being detected by the first solid state imaging device, and
wherein the color separation prism is a color separation prism according to claim 20.

22. A dual-type solid state color image pickup apparatus comprising:
a color separation prism that separates incident light from an object into first and second colors, and a third color of three primary colors;
a first solid state imaging device that receives incident light of the separated first and second colors that is separated by the color separation prism; and
a second solid state imaging device that receives incident light of the third color that is separated by the color separation prism,
wherein first light receiving portions, formed in an array pattern in the first solid state imaging device, for receiving light of the first and second colors are equal in number to second light receiving portions, formed in an array pattern in the second solid state imaging device, for receiving light of the third color, and
wherein the color separation prism is a color separation prism according to claim 20.

23. A dual-type solid state color image pickup apparatus comprising:
a color separation prism that separates incident light from an object into first and second colors, and a third color of three primary colors;
a first solid state imaging device that receives incident light of the separated first and second colors that is separated by the color separation prism; and
a second solid state imaging device that receives incident light of the third color that is separated by the color separation prism,
wherein each of a plurality of first light receiving portions, formed in the first solid state imaging device, outputs (i) a corresponding first pixel signal of a plurality of first pixel signals by which a first image signal is generated and (ii) a corresponding second pixel signal of a plurality of second pixel signals by which a second image signal is generated, and
wherein the color separation prism is a color separation prism according to claim 20.

24. A digital camera comprising a dual-type solid state color image pickup apparatus according to claim 1.

25. A digital camera comprising a dual-type solid state color image pickup apparatus according to claim 3.

26. A digital camera comprising a dual-type solid state color image pickup apparatus according to claim 4.

27. A digital camera comprising a dual-type solid state color image pickup apparatus according to claim 21.

28. A digital camera comprising a dual-type solid state color image pickup apparatus according to claim 22.

29. A digital camera comprising a dual-type solid state color image pickup apparatus according to claim 23.
